(19) United States
(12) Patent Application Publication
(10) Pub. No.: US 2005/0186380 A1
(43) Pub. Date: Aug. 25, 2005

(54) Recording medium and hard disk device using same

(75) Inventor: Junsei Ueda, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/058,684

(22) Filed: Feb. 15, 2005

(30) Foreign Application Priority Data
Feb. 20, 2004 (JP) 2004-043761

(51) Int. Cl. G11B 5/82; B32B 3/02

(52) U.S. Cl. 428/64.2; 427/128

(57) ABSTRACT

The upper surface of a recording medium includes a contact start stop (CSS) zone where projections are provided, and a data zone where data is recorded. The upper surface of the CSS zone is lower than the upper surface of the data zone. The upper surfaces of the projections are higher than the upper surface of the data zone.

This application claims the benefit of Japanese Patent Application No.: 2004-043761, which was filed on Feb. 20, 2004, and which is incorporated herein in its entirety.

### FIELD OF THE INVENTION

The present application relates to a recording medium mounted in a hard disk device and, more specifically, it relates to a recording medium that may maintain the flying altitude of the slider and may prevent the slider from being attracted to the upper surface of the recording medium.

### BACKGROUND

Hard disk devices include a recording medium, and when reading or writing of data is performed, the recording medium is rotated. In some hard disk devices, when the recording medium is at rest, a slider is in contact with the upper surface of the recording medium. When the recording medium is rotated, airflow is generated by the rotation creating a lift force. Being pressed by the lift force, the slider flies above the recording medium and maintains a fixed altitude. After the reading or writing is completed, the altitude of the slider decreases as the rotation of the recording medium slows down, and when the rotation of the recording medium is stopped, the slider again comes into contact with the upper surface of the recording medium.

Such hard disk devices are called contact start stop (CSS) type. Since they have a comparatively simple mechanism, they are widely used today.

In the CSS-type hard disk devices, microscopic roughness called “texture” is provided on the upper surface of the recording medium. When the recording medium starts rotating, the texture serves to break the contact between the slider and the recording medium with a smaller rotating force. When the recording medium is being rotated, the texture serves to maintain the flying altitude of the slider.

Recently, the recording density has been improved significantly and it may be desirable to reduce the distance between the slider and the recording layer. In view of this, flying altitude of the slider may be lower with respect to the recording layer. Consequently, it may be necessary to increase the degree of smoothness of the upper surface of the recording medium. However, increasing the degree of smoothness of the upper surface of the recording medium makes the slider tend to be attracted to the upper surface of the recording medium, and makes it difficult to maintain the flying altitude of the slider.

There is a recording medium called a zone texture recording medium. The upper surface of this recording medium is separated into a CSS zone and a data zone. When the recording medium is at rest, the slider is in contact with the CSS zone. Recording signals are recorded in the data zone. Texture is provided only in the CSS zone.

Such a zone texture recording medium is disclosed in Japanese Unexamined Patent Application Publication No. 10-255256 (hereinafter referred to as Patent Document 1).

In the hard disk device disclosed in Patent Document 1, the texture is formed of a large number of projections (laser bumps). The heights of the projections provided in the CSS zone is equal to or lower than the height of the upper surface of the data zone.

Therefore, in the hard disk device disclosed in Patent Document 1, the slider cannot fly above the data zone at a sufficient altitude, and the slider tends to be attracted to the upper surface of the recording medium.

If the slider comes into contact with the rotating recording medium, the recording medium and the slider may be damaged.

### SUMMARY

The present application relates to a recording medium and a recording device that maintains the flying altitude of a slider and prevents the slider from being attracted to the upper surface of the recording medium, and methods of manufacturing the recording medium.

In a first aspect, a recording medium includes a substrate, and a recording layer on the substrate. The upper surface of the recording medium includes a contact-start-stop (CSS) zone where projections are provided, and a data zone where data is recorded. The upper surface of the CSS zone is lower than the upper surface of the data zone, whereas the upper surfaces of the projections are higher than the upper surface of the data zone. In this application, height is measured in the direction from the lower surface of the substrate to the upper surface of the recording layer.

In the recording medium, the upper surface of the CSS zone is lower than the upper surface of the data zone. Even if the height of the projections provided on the upper surface of the CSS zone is large, the height distance from the upper surface of the data zone to the upper surfaces of the projections is small. Therefore, when the recording medium is rotated, the slider is lifted effectively.

In another aspect, the height distance from the upper surface of the data zone to the upper surfaces of the projections is small, and the flying altitude of the slider can be sufficiently low to read or record high-density records.

The projections may be formed according to a pattern on the substrate. Alternatively, the projections may be formed from a resist layer or a metallic material layer deposited on the substrate.

In yet another aspect, a hard disk device includes a recording medium and a magnetic head. The recording medium includes a substrate and a recording layer on the substrate. The upper surface of the recording medium includes a contact-start-stop (CSS) zone where projections are provided, and a data zone where data is recorded. The upper surface of the CSS zone is lower than the upper surface of the data zone. However, the upper surfaces of the projections are higher than the upper surface of the data zone. The magnetic head includes a slider and an arm supporting the slider. The slider is in contact with the CSS zone when the recording medium is not rotating, and flies above the data zone when data is written in the recording medium or data is read from the recording medium.

In the hard disk device, the upper surface of the CSS zone of the recording medium is lower than the upper surface of the data zone. Even if the height of the projections provided on the upper surface of the CSS zone is large, the height from the upper surface of the data zone to the upper surfaces of the projections may be small. Therefore, when the recording medium is rotated, since the height of the projections necessary for lifting the slider is ensured, the slider is lifted effectively.

### BRIEF DESCRIPTION OF THE DRAWINGS

FIG. 1 is a perspective view showing part of a hard disk device including a recording medium according;

FIG. 2 is a plan view showing the recording medium;

FIG. 3 is a sectional view taken along line III-III of FIG. 2;

FIG. 4 is a schematic sectional view showing the configuration of the upper surface of the recording medium;

FIG. 5 is an enlarged perspective view showing part of the recording medium;

FIG. 6 is an enlarged sectional view showing part of the recording medium being rotated in the hard disk device;

FIG. 7 shows a stage in a process for manufacturing the recording medium;

FIG. 8 shows a stage that follows the stage of FIG. 7;

FIG. 9 shows a stage in another process for manufacturing the recording medium;

FIG. 10 is an enlarged perspective view showing the stage of FIG. 9;

FIG. 11 shows a stage in another process for manufacturing the recording medium;

FIG. 12 shows a stage that follows the stage of FIG. 11;

FIG. 13 shows a stage that follows the stage of FIG. 12; and

FIG. 14 is an enlarged perspective view showing the stage of FIG. 13.

### DETAILED DESCRIPTION

Exemplary embodiments may be better understood with reference to the drawings, but these embodiments are not intended to be of a limiting nature. Like numbered elements in the same or different drawings perform equivalent functions.

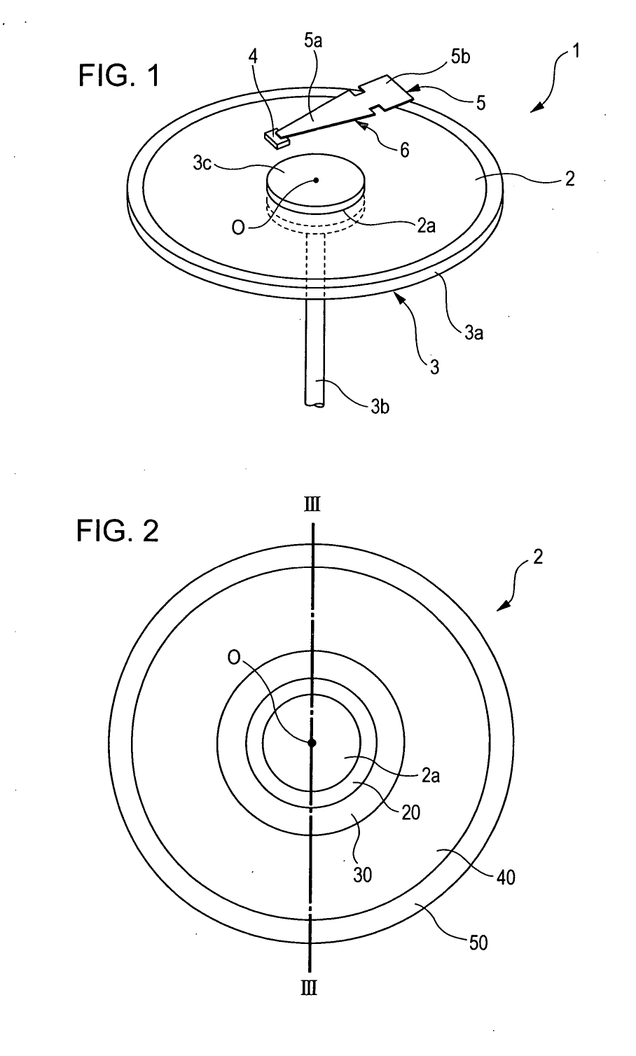

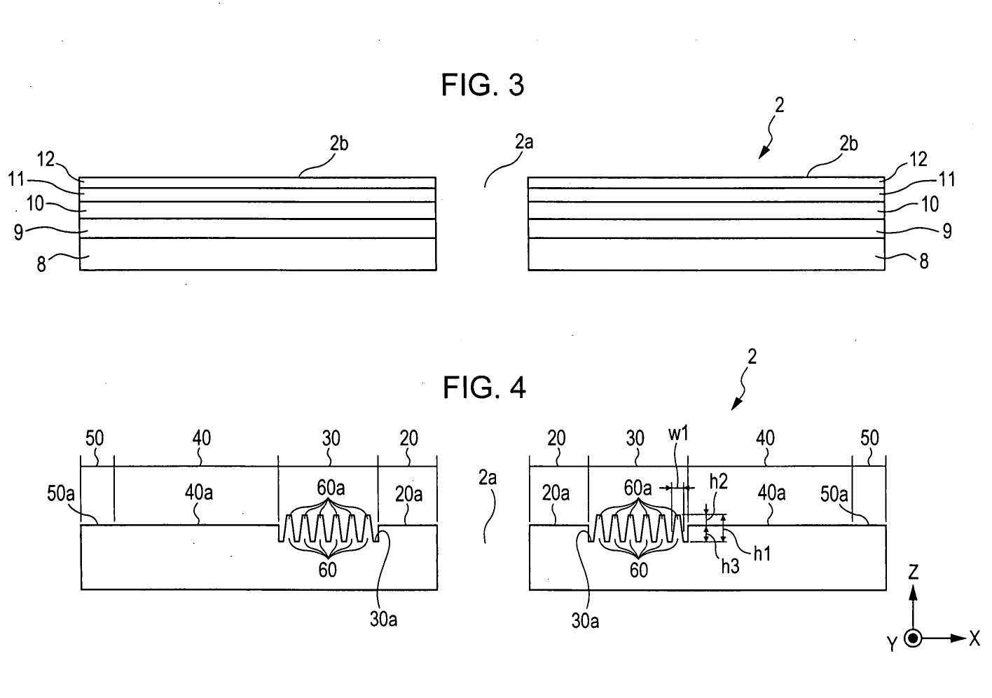

FIG. 1 is a perspective view showing part of a hard disk device including a recording medium; FIG. 2 is a plan view showing the recording medium; FIG. 3 is a sectional view taken along line III-III of FIG. 2; FIG. 4 is a schematic sectional view showing the configuration of the upper surface of the recording medium.

As shown in FIG. 1, the hard disk device 1 includes a plate-shaped recording medium 2 and a driver 3. The recording medium 2 is held on a holding plate 3a of the driver 3. A center hole 2a is provided in the center of the recording medium 2. A projection 3c is provided in the center of the holding plate 3a. The projection 3c is inserted into the center hole 2a so that the recording medium 2 is held on the holding plate 3a. The holding plate 3a is fixed on the tip of a drive shaft 3b. The drive shaft 3b rotates together with the holding plate 3a, thereby rotating the recording medium 2 around the point 0, and the axis defined by the drive shaft 3b.

As shown in FIG. 1, the hard disk device 1 further includes a magnetic head 6. The magnetic head 6 includes a slider 4 and an arm 5 supporting the slider 4.

The arm 5 includes a load beam 5a and a flexure (not shown). The flexure is provided at the tip of the load beam 5a. The load beam 5a is a leaf spring which may be formed of stainless-steel. The flexure is a thin leaf spring which may be formed of stainless-steel.

The end portion of the load beam 5a exerts a predetermined elastic pressure. A mount 5b is provided at the base end of the load beam 5a. The mount 5b is fixed on a mounting surface (not shown) of the hard disk device 1. In this way, the magnetic head 6 may be mounted in the hard disk device 1.

The slider 4 may be formed of a ceramic material such as alumina titanium carbide (Al₂O₃—TiC), or other suitable material as is known in the art.

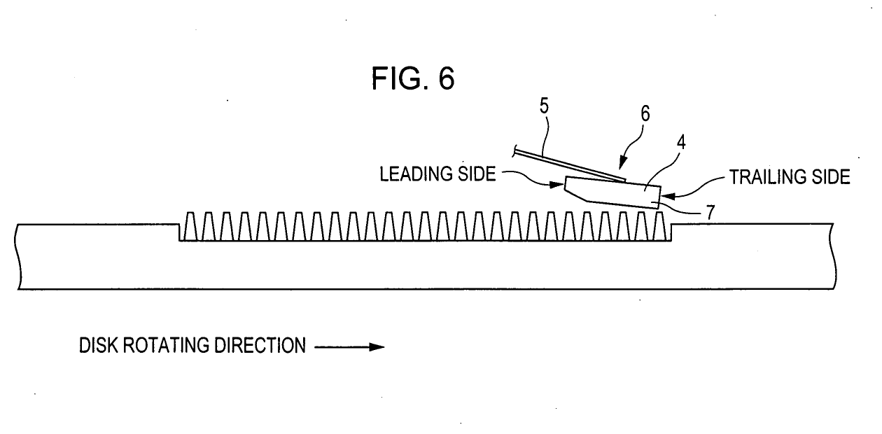

A thin film element 7 is provided on the trailing side of the slider 4 (see FIG. 6). The thin film element 7 may include a thin film reading element and a thin film writing element (not shown). The thin film reading element may use the magnetoresistance effect. The thin film writing element may be an inductive-type element. The thin film element 7 may include only a thin film reading element or only a thin film writing element.

The recording medium 2 stores information. The recording medium 2 may be detachably or permanently mounted on the hard disk device 1. The thin film element 7 provided in the magnetic head 6 reads or writes information. The recording media 2 may at least one of a magnetic disk, a magneto-optical disk, and an optical disk. In the case of FIGS. 1 to 6, the recording medium 2 is a magnetic disk.

As shown in FIG. 3, the recording medium 2 may include four layers formed on a substrate 8. The bottommost layer is an underlayer 9. The second layer from the bottom is a magnetic material layer 10. The third layer from the bottom is a protection layer 11. The fourth layer from the bottom is a lubricant layer 12.

The substrate 8 may be formed of a non-magnetic material such as aluminum, NiP-plated aluminum, glass, or resist.

The underlayer 9 may be formed of a metallic material such as chromium. The magnetic material layer 10 may be formed of a metallic material having suitable magnetic properties such as a magnetic cobalt alloy film. Cobalt alloys may include Co, Co—Ni, Co—Ni—Cr, Co—Cr, Co—Cr—Ta, and Co—Pt.

The protection layer 11 may be formed of carbon. The lubricant layer 12 may be formed of a fluorinated liquid lubricant such as perfluoropolyether (PFPE) or a solid lubricant such as molybdenum disulfide.

The magnetic recording medium 2 shown in FIGS. 1 to 3 is called a contact start stop (CSS) type.

In the hard disk device 1, when the recording medium 2 is at rest, the slider 4 is in contact with the upper surface 2b of the recording medium 2. When the recording medium 2 is rotated, airflow is generated by the rotation. Being pressed by the airflow, the slider 4 flies above the recording medium 2 and maintains a fixed altitude. After the reading or writing is completed, the altitude of the slider 4 decreases as the rotation of the recording medium 2 slows down. When the rotation of the recording medium 2 is stopped, the slider 4 again comes into contact with the upper surface 2b of the recording medium 2.

In the hard disk device 1 using the CSS-type recording medium 2, the slider 4 is urged by the arm 5 with a weak elastic force against the upper surface 2b of the recording medium 2. Before starting rotation of the recording medium 2, the slider 4 is in contact with the upper surface 2b of the recording medium 2. At the start of rotation of the recording medium 2, airflow is generated on the upper surface 2b of the recording medium 2. Due to this airflow, lifting force is exerted on the slider 4. As shown in FIG. 6, the leading side of the slider 4 is lifted higher than the trailing side of the slider 4 off the upper surface 2b of the recording medium 2. The trailing side is lifted slightly off the recording medium 2. The tilted slider 4 scans the upper surface 2b of the recording medium 2.

The recording medium 2 shown in FIGS. 1 to 3 is a CSS-type recording medium called a zone texture recording medium. The upper surface 2b of the recording medium 2 is separated into a CSS zone and a data zone. When the recording medium 2 is at rest, the slider 4 is in contact with the CSS zone. Recording signals are recorded in the data zone; texture is provided only in the CSS zone.

As shown in FIGS. 2 and 4, a ring-shaped lead-in zone 20 may be provided around the center hole 2a of the recording medium 2. A ring-shaped CSS zone 30 is provided around the lead-in zone 20. A ring-shaped data zone 40 is provided around the CSS zone 30. A ring-shaped lead-out zone 50 is provided around the data zone 40.

The lead-in zone 20 and the lead-out zone 50 serve as an empty area where no data is recorded, however, lead-in zone 20 and the lead-out zone 50 need not be provided.

The CSS zone 30 is an area with which the slider 4 is in contact when the recording medium 2 is at rest. The data zone 40 is an area in which data is already written or to be written.

As shown in FIG. 4, projections 60a are provided on the upper surface 30a of the CSS zone 30. The height h1 of the projections 60a is 10 nm to 15 nm. The width W1 of the projections 60 in the X-direction or Y-direction in FIG. 4 is 1 μm to 20 μm.

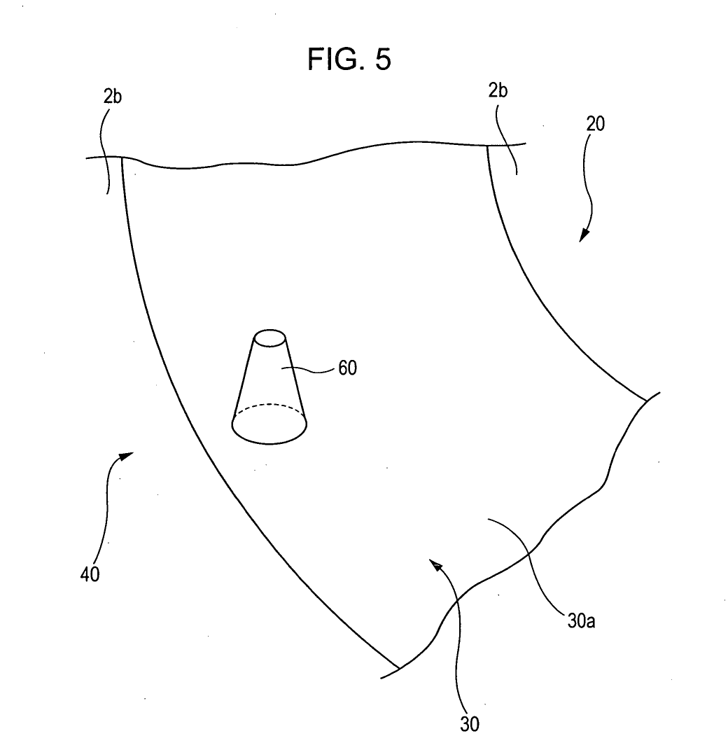

FIG. 5 is an enlarged perspective view showing a projection 60. Although only one projection 60 is shown in FIG. 5 in order to explain the shape of the projection 60 simply, the actual recording medium 2 is provided with a large number of projections 60. As shown in FIG. 5, the projection 60 is frustroconical.

As shown in FIG. 4, the upper surface 30a of the CSS zone 30 is lower than the upper surface 20a of the lead-in zone 20, the upper surface 40a of the data zone 40, and the upper surface 50a of the lead-out zone 50. On the other hand, the upper surfaces 60a of the projections 60 are higher than the upper surface 20a of the lead-in zone 20, the upper surface 40a of the data zone 40, and the upper surface 50a of the lead-out zone 50. The upper surface 20a of the lead-in zone 20, the upper surface 40a of the data zone 40, and the upper surface 50a of the lead-out zone 50 may have the same height. The height h2 from the upper surfaces 20a, 40a, and 50a to the upper surfaces 60a of the projections 60 is preferably 1 nm to 5 nm.

As described above, the height h1 of the projections 60 is 10 nm to 15 nm, and the height h2 from the upper surfaces 20a, 40a, and 50a to the upper surfaces 60a of the projections 60 is 1 nm to 5 nm. Therefore, the height h3 from the upper surface 30a of the CSS zone 30 to the upper surfaces 20a, 40a, and 50a is 5 nm to 14 nm.

In the recording medium 2, the upper surface 30a of the CSS zone 30 is h3 lower than the upper surface 20a of the lead-in zone 20, the upper surface 40a of the data zone 40, and the upper surface 50a of the lead-out zone 50. Therefore, even if the height h1 is large, the height h2 is small (1 nm to 5 nm). Therefore, when the recording medium 2 is rotated, since the height h1 necessary for lifting the slider 4 is ensured, and the slider 4 is lifted effectively as shown in FIG. 6.

On the other hand, since the height h2 is small, the flying altitude of the slider 4 can be sufficiently low to read or record high-density records.

The upper surfaces 60a of the projections 60 are preferably h2 higher than the upper surfaces 20a, 40a, and 50a, as in the recording medium 2. In the recording medium 2, since the upper surfaces 60a of the projections 60 are h2 higher than the upper surfaces 20a, 40a, and 50a, the flying altitude of the slider 4 is sufficient.

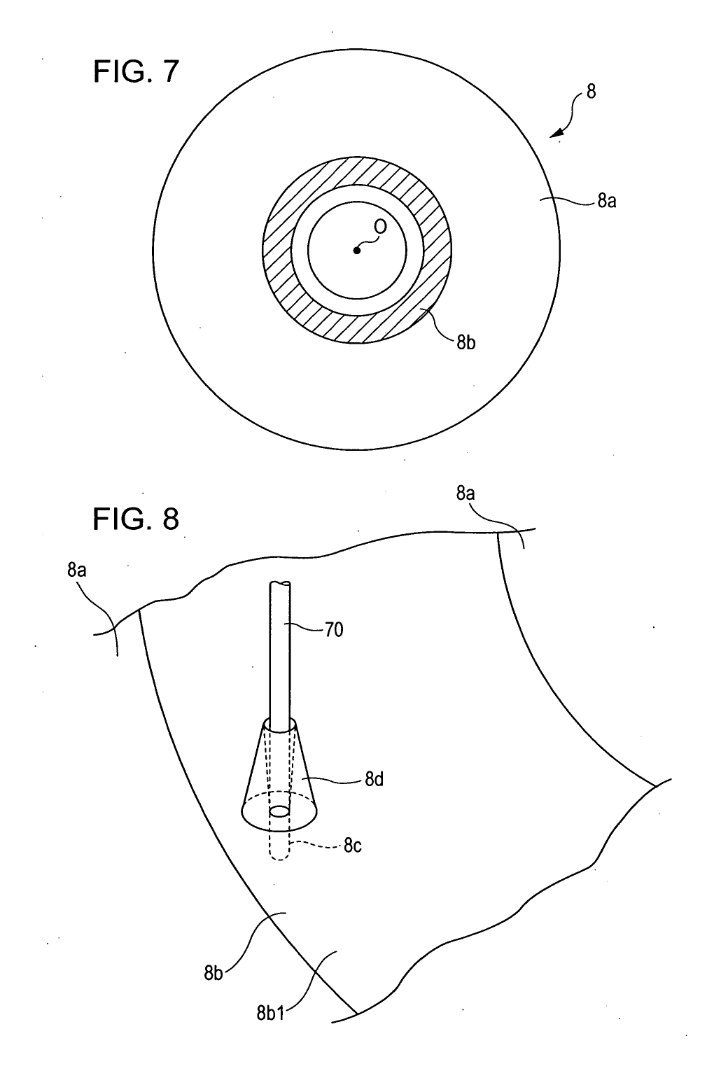

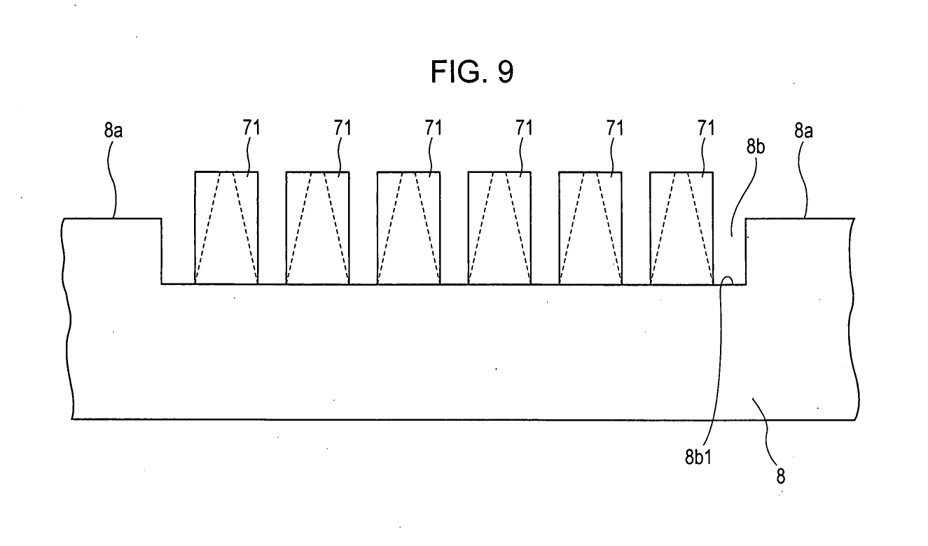

A first method for forming the projections 60 will be described. FIG. 7 is a plan view showing a substrate 8. FIG. 8 is a perspective view showing part of the substrate 8.

As shown in FIG. 7, the upper surface 8a of the substrate 8, except for the hatched portion, is covered with a resist layer. Then, the upper surface Ba of the hatched portion is removed by etching. In this way, a groove 8b is formed.

Next, as shown in FIG. 8, the upper surface 8b1 of the groove 8b is irradiated with laser light 70. Due to the heat of the laser light 70 (the path of the laser light being illustrated), a hole 8c is formed in the groove 8b. In addition, a conical projection 8d is formed around the hole 8c.

In this way, a plurality of projections 8d is formed in the groove 8b. The underlayer 9 is then formed on the substrate 8 by sputtering. Next, the magnetic material layer 10 and the protection layer 11 are formed on the underlayer 9. Lastly, the lubricant layer 12 is applied to the upper surface of the protection layer 11.

As described above, the underlayer 9, the magnetic material layer 10, the protection layer 11, and the lubricant layer 12 are formed on the substrate 8 including the groove 8b and the projections 8d. The layers 9, 10, 11, and 12 are patterned by the shape of the groove 8b and the projections 8d. In this way, the recording medium 2 is manufactured.

Therefore, a groove and projections are formed on the upper surface 2b of the recording medium 2. The CSS zone is located over the groove 8b and has the same shape as the groove 8b. The projections are located over the projections 8d and have a determined by the projections 8d. The portion on the upper surface 2b corresponding to the groove 8b and the projections 8d serves as the CSS zone 30 of the recording medium 2. The portion on the upper surface 2b corresponding to the upper surface 8b1 of the groove 8b serves as the upper surface 30a of the CSS zone 30. The portions on the upper surface 2b corresponding to the projections 8d serve as the projections 60.

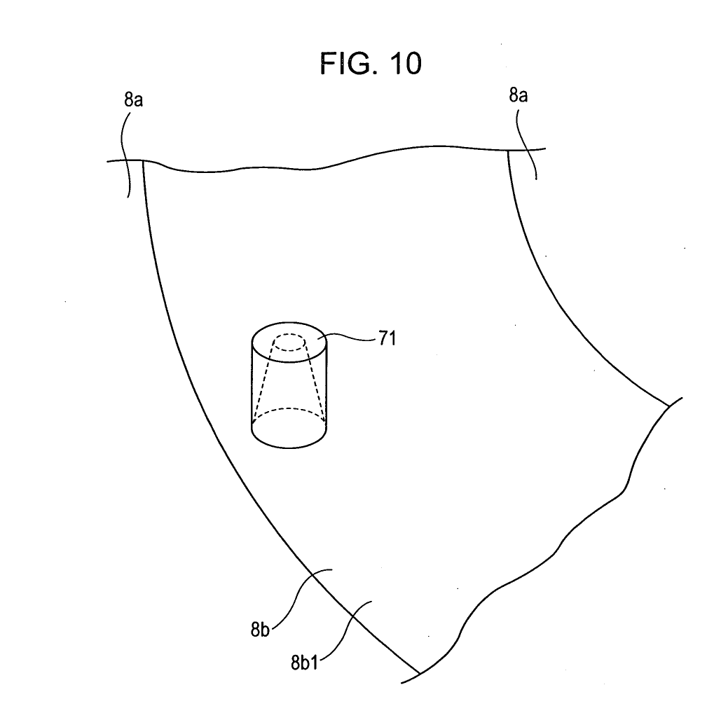

A second method for forming the projections 60 will be described. FIGS. 9 and 10 show aspects of the second method.

First, a groove 8b is formed in the substrate 8 according to the same process as described in the first method. After this, as shown in FIG. 9, resist columns 71 are formed from a resist layer on the upper surface 8b1 of the groove 8b. The resist columns 71 are formed of materials and by processes known in the art, such as a photolithographic technique. FIG. 10 is an enlarged perspective view showing a resist column 71. Although only one resist column 71 is shown in FIG. 10 in order to explain the shape of the resist column 71 simply, the actual recording medium 2 is provided with a large number of resist columns 71. As shown in FIG. 10, the resist column 71 is cylindrical; however, the resist column 71 may have another shape such as a prismatic shape.

The resist columns 71 may be shaped by milling, reactive ion etching or similar process into the shape shown by dashed lines in FIGS. 9 and 10. In this way, the projection 60 shown in FIG. 5 is formed.

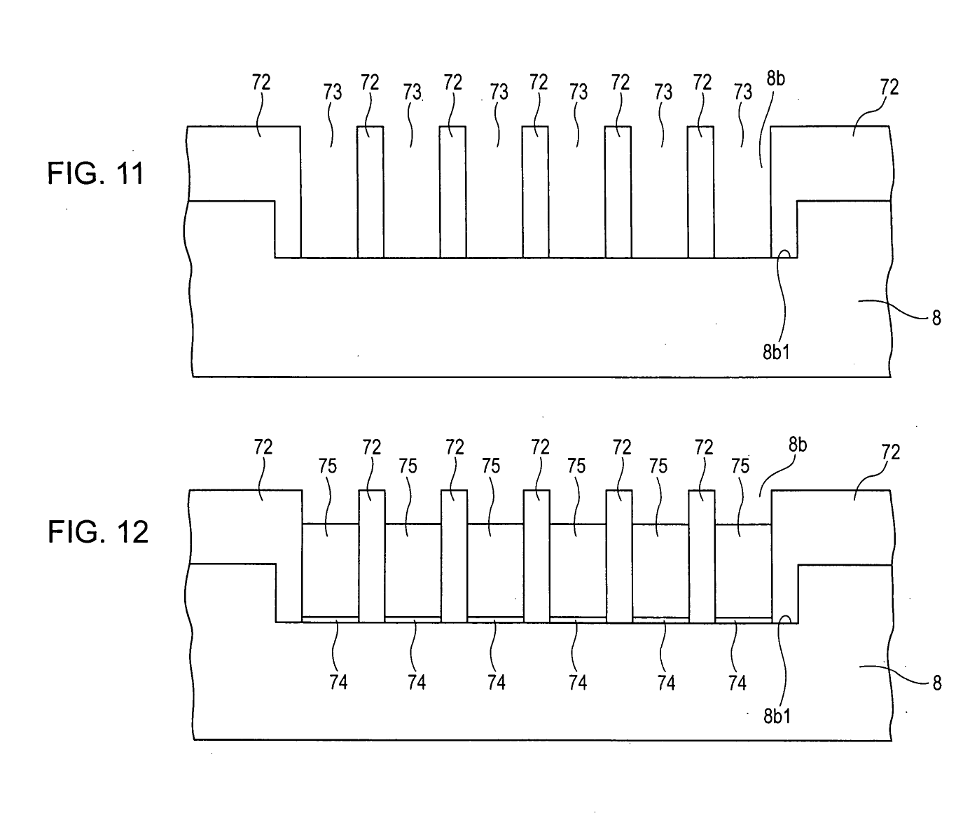

A third method for forming the projection 60 will be described. FIGS. 11 to 14 show aspects of the third method.

First, a groove 8b is formed in the substrate 8 according to the same process as described in the first method. After this, as shown in FIG. 11, a resist layer 72 is formed on the upper surface 8b1 of the groove 8b so as to form a frame pattern 73. This resist layer 72 is formed are formed of materials and by processes known in the art, such as a photolithographic technique.

Next, as shown in FIG. 12, a seed layer 74 is formed in the frame pattern 73. After this, a metallic material layer 75 is formed on the seed layer 74. The metallic material layer 75 may be formed by plating. The metallic material layer 75 may be formed of nickel, iron, or copper. A plurality of kinds of metallic material layers may be provided.

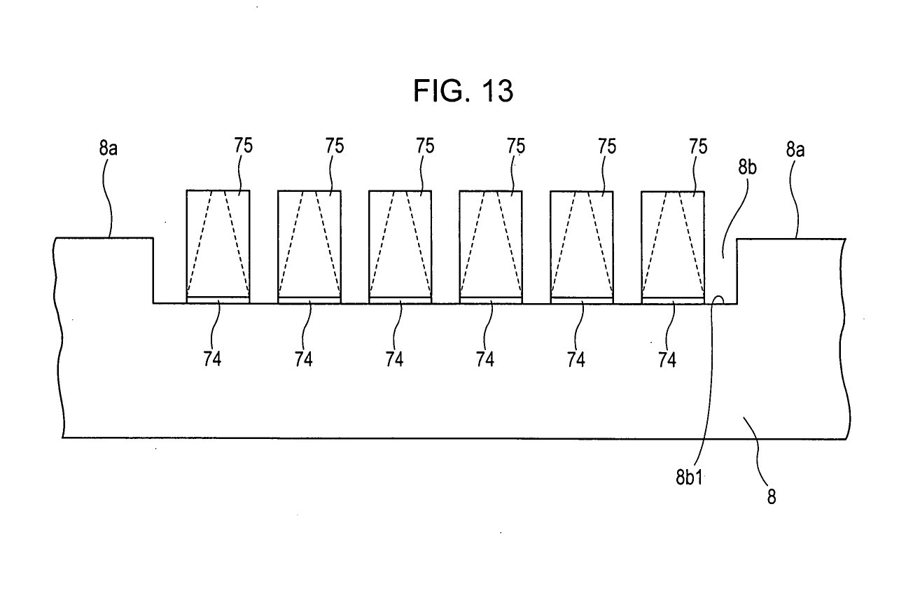

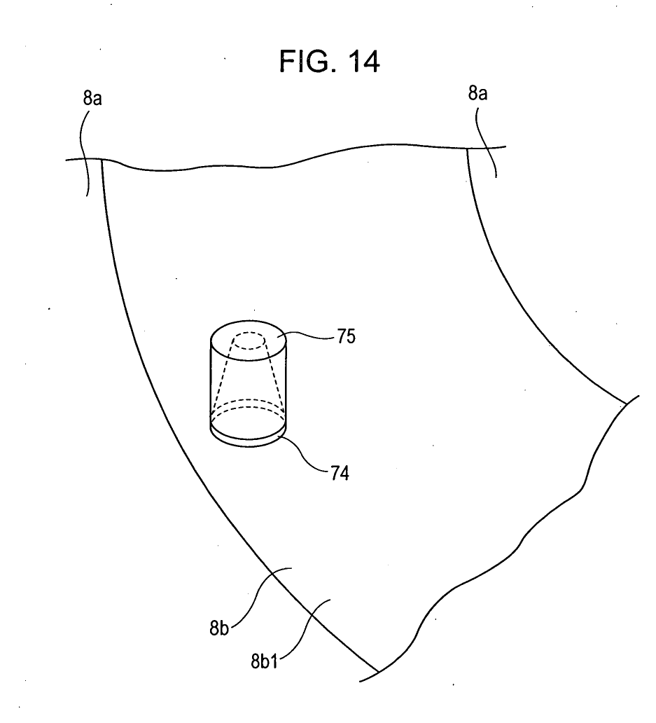

Next, as shown in FIG. 13, the resist layer 72 is removed. The seed layer 74 and the metallic material layer 75 remain on the upper surface 8b1 of the groove 8b and form metallic material columns. FIG. 14 is an enlarged perspective view showing a metallic material column. Although only one metallic material column is shown in FIG. 14 in order to explain the shape of the metallic material column simply, the actual recording medium 2 is provided with a large number of metallic material columns. As shown in FIG. 14, the metallic material column formed of the seed layer 74 and the metallic material layer 75 may be cylindrical. The metallic material column may have another shape such as a prismatic shape.

Next, the metallic material columns are shaped by milling, reactive ion etching or similar process into the shape shown by dashed lines in FIGS. 13 and 14. In this way, the projection 60 shown in FIG. 5 is formed.

In the case where the substrate 8 is formed of a metallic material, the seed layer 74 may not be necessary.

The shape of the projection 60 is not limited to a conical shape. The projection 60 may have another shape such as a cylindrical shape or a prismatic shape.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

1. A recording medium comprising:
a substrate; and
a recording layer on the substrate, the upper surface of the recording medium comprising:
a contact start stop (CSS) zone where projections are provided; and
a data zone where data is recorded,
the upper surface of the CSS zone being lower than the upper surface of the data zone, the upper surfaces of the projections being higher than the upper surface of the data zone.

2. The recording medium according to claim 1, wherein the height h1 of the projections is 10 nm to 15 nm.

3. The recording medium according to claim 1, wherein the height h2 from the upper surface of the data zone to the upper surfaces of the projections is 1 nm to 5 nm.

4. The recording medium according to claim 1, wherein the height h3 from the upper surface of the CSS zone to the upper surface of the data zone is 5 nm to 14 nm.

5. The recording medium according to claim 1, wherein the projections are formed according to a pattern on the substrate.

6. The recording medium according to claim 1, wherein the projections are formed out of a resist layer.

7. The recording medium according to claim 1, wherein the projections are formed out of a metallic material layer.

8. A hard disk device comprising:
a recording medium comprising:
a substrate; and
a recording layer on the substrate,
the upper surface of the recording medium comprising:
a contact start stop (CSS) zone where projections are provided; and
a data zone where data is recorded,
the upper surface of the CSS zone being lower than the upper surface of the data zone, the upper surfaces of the projections being higher than the upper surface of the data zone; and
a magnetic head comprising:
a slider that is in contact with the CSS zone when the recording medium is not rotating, and flies above the data zone when data is written in the recording medium or data is read from the recording medium; and
an arm supporting the slider.

9. A method of manufacturing a recording medium, the method comprising:
providing a circular substrate,
etching an annular ring disposed between a first radial distance from the axis of the substrate and a second radial distance from the circumference of the substrate;
forming a plurality of projections on the surface of the annular ring; and
forming a magnetic recording layer, a protective layer and a lubricating layer on the surface of the circular substrate, in that order.

10. The method according to claim 9, wherein the plurality of projections is formed by laser heating of the surface of the annular ring.

11. The method according to claim 9, wherein the plurality of projections is formed by photolithography.

12. The method according to claim 9, wherein the plurality of projections is formed by:
depositing a resist layer on the annular grove on the surface of the circular substrate; and
patterning the resist so as to produce shaped projections.

13. The method according to claim 9, wherein the plurality of projections is formed by:
forming a resist layer on the circular surface, including the annular groove;
patterning the resist layer on the annular groove to form a frame pattern;
depositing a metallic layer on the exposed areas of the annular groove; and
removing the resist pattern.

14. The method according to claim 13, wherein the depositing the metallic layer includes depositing a seed layer of metal prior to depositing the metallic layer.

15. The method according to claim 9, wherein the projections are shaped by one of etching and ion milling, prior to forming the magnetic recording layer.

16. A recording medium comprising:
a substrate; and
means for storing recorded data, the means for storing data further comprising:
means for magnetic storage; and
means for contacting the slider,
wherein the means for contacting the slider and the means for magnetic storage are disposed on separate annular portions of the substrate.

17. A recording medium according to claim 16, wherein a slider comprising at least one of a recording and reproducing head is in contact with the means for contacting when the recording medium is stationary and the slider is not in contact with the means for magnetic storage and the means for contacting when the medium is rotating.

18. A hard disk device comprising:
a recording medium, further comprising:
a substrate; and
means for storing recorded data, the means for storing data further comprising:
means for magnetic storage; and
means for contacting;
a magnetic head comprising:
a slider that is in contact with the means for contacting when the recording medium is stationary, the slider flying above the means for magnetic storage when the recording medium is rotating; and
an arm supporting the slider.
